(19) United States
(12) Patent Application Publication
(10) Pub. No.: US 2020/0359472 A1
(43) Pub. Date: Nov. 12, 2020

(54) CONTROLLABLE ILLUMINATION SYSTEM AND METHOD FOR SANITARY ENVIRONMENTS

(71) Applicant: THE KIRLIN COMPANY, Detroit, MI (US)

(72) Inventors: Joseph STRELCHUK, Clarkston, MI (US); Jana K. BROWNELL, Grosse Pointe Farms, MI (US); Chad ECKHOUT, Shelby Township, MI (US)

(21) Appl. No.: 16/407,959

(22) Filed: May 9, 2019

(51) Int. Cl. H05B 37/02; B08B 7/00; F21V 21/14; F21V 21/04

(52) U.S. Cl. CPC H05B 37/0272; F21V 21/04; F21V 21/14; B08B 7/0035

(57) ABSTRACT

A controllable illumination system and method comprising: (1) one or more light fixtures; (2) a controller in communication with at least some of the light fixtures; (3) a status identifier associated with at least some of the light fixtures that indicates whether the light fixture is under the influence of the controller; and (4) software in communication with the controller and the one or more light fixtures that is adapted to influence one or more light fixture characteristics, including beam direction, beam color, beam size, beam shape and intensity of beams that emanate from a light fixture.

### TECHNICAL FIELD

In at least one aspect, the present invention is related to a controllable illumination system and method, primarily for use in a sanitary environment.

### BACKGROUND OF THE INVENTION

(1) Field of the Invention

In some sanitary environments, an operator is challenged with determining how to effectively illuminate a work site (e.g., a zone of interest on a patient in an operating room) without using any methods (e.g., physical contact) or introducing any devices (e.g., a wand) that could introduce or spread contamination.

Conventional devices tend to occupy scarce space in the environment of use. Further, they may be bulky or heavy. Re-positioning often requires physical exertion and hands on intervention, which will compromise sanitary environments.

Existing control methods may require the operator to manually move the light fixtures, make adjustments by pushing buttons or flipping switches (via hand or foot), which may or may not be sanitary.

In the operating theater, precisely aimed illumination of pre-defined characteristics is needed for safe surgery and effective patient treatment. Ideally, illumination is of the desired intensity and color. Preferably, it should not cast a shadow.

Ideally, acceptable solutions to the problem of controlling lighting in a sanitary environment requires immediate and precise control of light fixtures, perhaps involving re-positioning or tilting, with minimal operator interaction.

Known representative products lack the ability to increase in scale as an illumination system. Further they lack color changing features.

### (2) Description of Related Art

Among the art considered in writing this patent application are (1) Lucina4 and Specialty by Skytron, www.skytron.us; (2) Power LED by Maquet, www.maquet.com; (3) INFRALED® and OPTeMED® by The Kirlin Company, www.kirlinlighting.com; and (4) commonly owned U.S. Pat. No. 5,526,245.

### BRIEF SUMMARY OF THE INVENTION

One aspect of this disclosure allows an operator to control an illumination system without compromising a sanitary environment (such as an operating room) by using one or more controllers, which may be hand-held, recessed in a ceiling or mounted on a substrate (e.g., a table or a wall or a portable board). Using such a controller, it would be desirable to be able to activate more lights or groups of lights (i.e., change their state—on/off), alter intensity, select color, determine position (aiming), indicate status (i.e., whether under the influence of a controller), select beam size and prescribe beam shape—all without touching a light fixture or a button connected to the light fixture. It is known that touching may compromise a sanitary environment.

It would be desirable to produce such results with ease, predictability and precision. For example, upon the touch of a button or upon sliding a tactile surface (e.g. a variable resistor, cold contact, or digital switch outside a sanitary field), light beams with a precisely intensity, color, position, size and shape may be aimed at, for example a patient in an operating room. Once suitably directed, one or more of the one or more light fixture(s) are aimed at a task site without the need for additional interactions.

In several embodiments, the controllable illumination system includes:
(1) one or more electromechanically energized light fixtures recessed in a ceiling or wall for light beam re-positioning or tilting;
(2) one or more controllers in wired or wireless communication with one or more of the light fixtures;
(3) a status identifier associated with one or more of the light fixtures that indicates whether a light fixture or group of light fixtures is under the influence of a controller; and
(4) software in communication with one or more of the controllers that is adapted to influence one or more beam characteristics of beams that emanate from one or more of the one or more light fixtures or a group thereof. The beam characteristics are selected from the group consisting of beam state (On/Off), beam intensity, beam color, beam movement, beam status indicator, beam size and beam shape that emanate from a light fixture or group of light fixtures.

In a hospital or outpatient environment, the patient—or in an electronic assembly facility, the device under examination is positioned on a table or a similar platform (“task site”). The operator will select the desired illumination characteristics and number of light fixtures to be activated and the location to which they are to be directed by activating a controller that is located away from the light fixture (sometimes termed herein as a “remote controller”).

Optionally, one or more additional controllers may be deployed.

In an alternative embodiment, light characteristics may be influenced and specified by voice activation.

In some cases, a controller may be embodied in a touch screen or touch pad.

The status identifier (e.g., a blue ring around a light fixture) signifies to an observer which light fixture or group of light fixtures is in an operational state in which a signal is being sent to and received by the light fixture or group thereof.

Actions performed by the operator are performed quickly and easily.

Preferably, each controller is positioned outside the sanitary environment. Thus, the chance of introducing contamination into the sanitary environment is virtually eliminated.

### BRIEF DESCRIPTION OF THE SEVERAL VIEWS OF THE DRAWINGS

FIG. 1 is a schematic illustration of a representative illumination system layout;

FIG. 2 shows exemplary signal flow paths between one controller and one or more light fixtures;

FIG. 3 is an example of two possible user interfaces associated respectively with two exemplary controllers;

FIG. 4 is a plan view of one embodiment of an illumination system directed at two work zones or task sites with a status identifier in which one or more light fixtures have the capability to produce beams of different specified characteristics, e.g., intensity, color, position, size and shape;

FIG. 5 is a plan view of one embodiment of an illumination system with a status identifier illuminated to indicate that a light fixture is under the influence of one or more controllers; and

FIG. 6 illustrates a representative status identifier associated with one or more of the light fixtures.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. Reference will now be made in detail to presently preferred embodiments and methods of the present disclosure, which constitute the best modes of practicing the invention presently known to the inventors.

The Figures are not necessarily to scale and some features may be exaggerated or minimized to show details of particular components. Specific details disclosed herein are not to be interpreted as limiting, but merely as a representative basis for any aspect of the invention and/or as a representative basis for teaching one skilled in the art to variously employ the present invention.

It must also be noted that, as used in the specification and the appended claims, the singular form “a,” “an,” and “the” comprise plural references unless the context clearly indicates otherwise. For example, reference to “a” component in the singular is intended to comprise one or more components.

The term “comprising” is synonymous with “including,” “having,” “containing,” or “characterized by.” These terms are inclusive and open-ended and do not exclude additional, unrecited elements or method steps.

Throughout this application, where publications or brochures or websites describing product names are referenced, the disclosures of these publications or brochures in their entireties are hereby incorporated by reference into this application to more fully describe the state of the art to which this invention pertains.

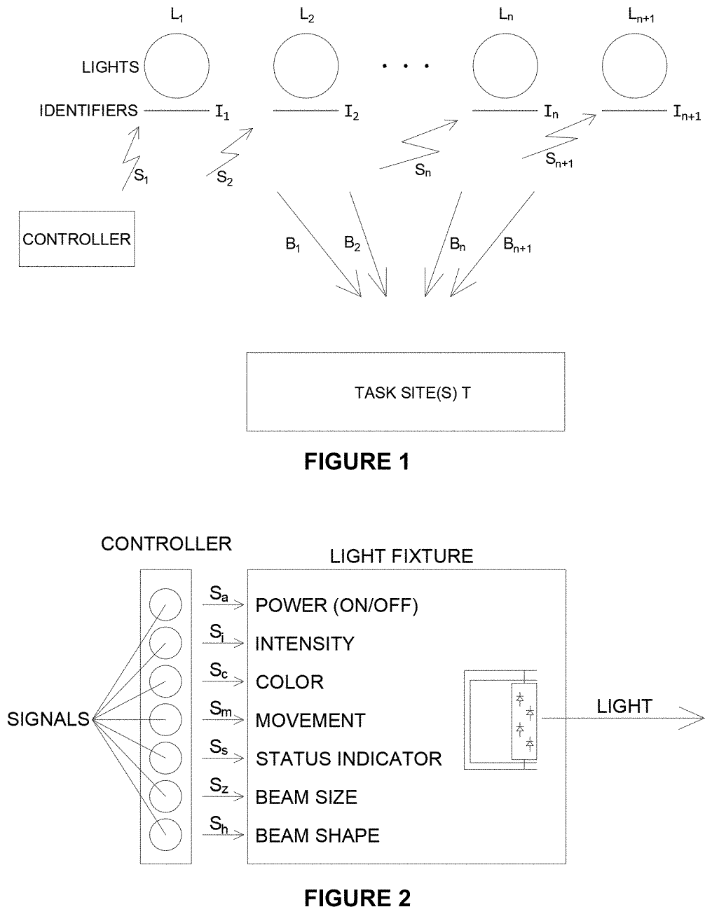

Several embodiments of this disclosure address the challenges of providing a versatile lighting system, primarily but not exclusively for use in sanitary environments. Desirably, an optimal illumination system (see, FIGS. 1-2) is such that operation of light fixtures does not introduce or spread contamination, while being able to deliver high quality, shadow-less light. Representative environments of use include but are not limited to an operating room in a hospital or a clean room in which electronic components are assembled.

Usually, the light fixtures of an illumination system are located on a wall or at the ceiling line of for example an operating theater. They typically lie away from the operator, thus avoiding the casting of shadows.

Preferably, one or more controllers are adapted to direct or influence the illumination system. This allows an operator to alter beam intensity, select beam color, adjust beam position by tilting an associated light fixture, shrink or expand beam size and/or configure its shape.

Optionally, one or more of the light fixtures have a visible status identifier that shows which light fixture(s) is under the present influence of one or more of the controllers at a given point in time. The visible status identifier may for example be embodied in a light strip or a dot or a ring around a recessed light fixture. This allows the operator to identify light fixture status from any vantage point.

The desired illumination to be cast in the environment of use (e.g., an operating room in a hospital or a clean room in a laboratory or an electronics assembly facility) depends on the demands of the varied tasks to be performed at a task site (e.g., a medical procedure or assembly of electronic components). This requires the illumination system to be scalable in terms of the number of light fixtures required to achieve a desired brightness or color and prevent the formation of shadows.

Optionally, the beams from the light fixtures may be directed in various alternative positions, depending on the task.

In several embodiments of the disclosed illumination system, an operator can aim, dim and change the color of light beams without introducing or spreading contamination into the sanitary environment.

Further, a single illumination system may include groups of light fixtures. Thus, one or more controllers may influence the beam characteristics of each fixture in a group. In this way, for example, a single command may cause each light fixture in a group to emit a beam that has characteristics identical to other light fixtures in that group. In alternative embodiments, a given light fixture may include several individual points of light.

In one exemplary embodiment, an illumination system may include a plurality of motorized light fixtures mounted in a ceiling. Each light fixture has a motorized aiming system that allows the light fixture and thus the beam that emanates therefrom to be directed properly towards the task site. Thus, for example a light fixture may move or tilt above the plane of a ceiling so that a resultant beam can be repositioned as needed.

Each light fixture may alternatively produce single or multiple colors. In some cases more than one color at a time may be generated.

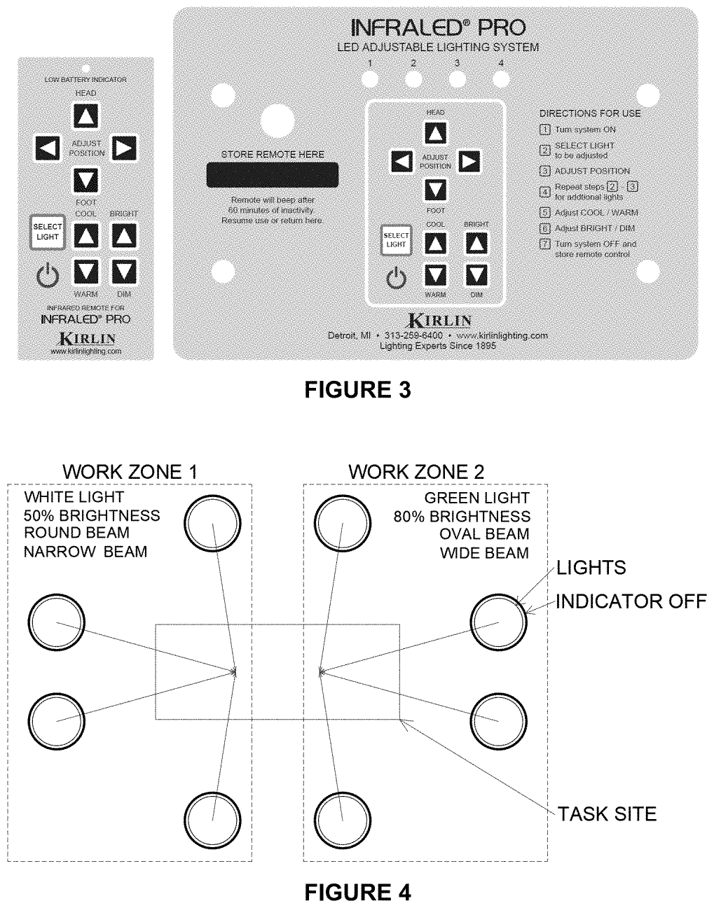

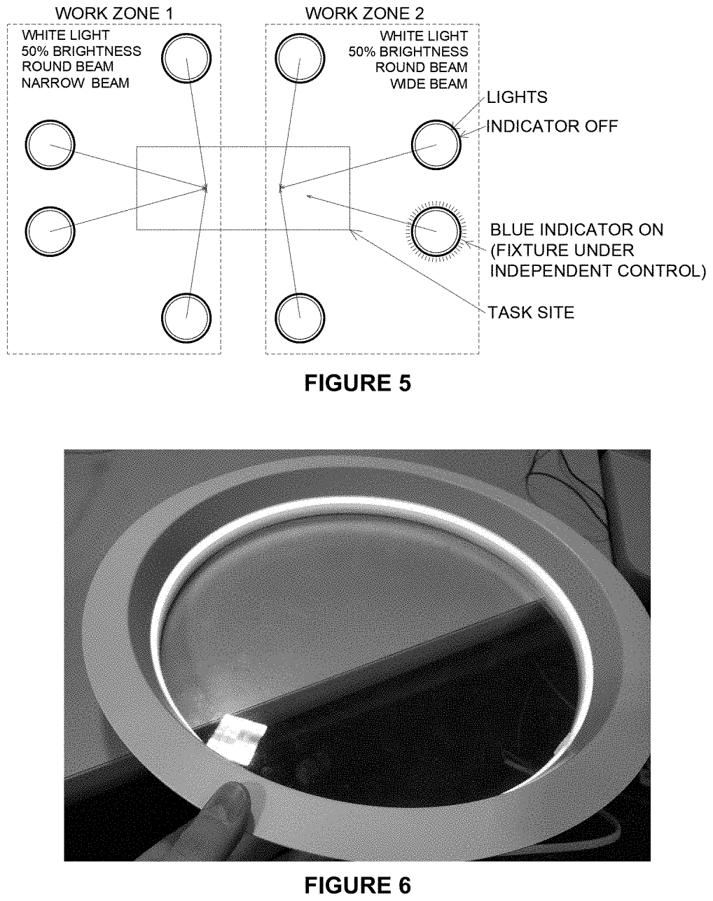

All or several light fixtures connect to a single or more than one controller via wireless or cabled means. One controller may for example be embodied in a central control panel and communicate with the light fixtures via one or more cables which transmit signals that influence beam characteristics. Alternatively, the illumination system may have a controller that includes an IR remote that replicates at least some of the controls of a wall-mounted panel (see, FIG. 3).

As noted above, when a controller influences a given light fixture or group thereof, a ceiling- or wall-mounted status indicator activates. That indicator preferably can be observed by an operator from most if not all places in the environment of use. Optionally, the remote controller may have a light feature that underlies or lies adjacent to a button, the light feature glowing when the button is active. In alternative embodiments, a controller in the form of a hand-held remote may communicate with a wall-mounted controller or directly to a receiver associated with a light fixture.

It will be appreciated that the subject under examination is located on a table or a similar work site. In use, the operator will turn on the illumination system, aim the light fixtures to their desired location, adjust their color and shape, and then set an appropriate brightness of illumination. Optionally such characteristics may be stored in memory for ready recall if needed.

As the operator selects light fixture(s) for aiming, the status indictor associated with that light fixture will allow the operator to confirm which light fixture(s) are in active or passive communication with the controller. Optionally, the status indicator may emit a light signal that differs, depending on the state (e.g., yellow when in transit—moving toward a desired position; or blue when stationary—at rest at the desired position).

FIG. 1 depicts the above-described light fixtures L₁, L₂ . . . Lₙ, Lₙ₊₁ in an illumination system or a group thereof in an illumination system. At least some of the light fixtures are associated with a respective status identifier I₁, I₂ . . . Iₙ, Iₙ₊₁ (e.g., a blue ring that encircles the light fixture). The controller sends one or more signals S₁, S₂ . . . Sₙ, Sₙ₊₁ respectively to the light fixtures L₁, L₂ . . . Lₙ, Lₙ₊₁. The light fixtures generate corresponding beams of light B₁, B₂ . . . Bₙ, Bₙ₊₁.

Consider in FIG. 2 illustrative signals Sₐ, Sᵢ, S_{c}, Sₘ, Sₛ, S_{z} and Sₕ that are transmitted to a light fixture Lₙ. Such signals may be transmitted along strands of a hard-wired cable or wirelessly. Those signals have unique characteristics (e.g., wavelength, frequency, etc.). A receiver associated with each light fixture receives those signals and activates an associated diode, filament or other light source. Such signals may be discrete (e.g., on/off) or be analog (e.g., low/medium/high, etc).

Here is a list of representative signals generated by one or more controllers:

Sₐ symbolizes a command signal that turns the light fixture on and off.

Sᵢ symbolizes a command signal that influences the desired intensity of the light fixture (e.g., subdued, brighter, brightest, etc.).

S_{c} symbolizes a command signal that specifies color (e.g., red, white, blue, etc.).

Sᵢ symbolizes a command signal that specifies intensity.

S_{c} symbolizes a command signal that specifies color.

Sₘ symbolizes a command signal that synchronizes with for example a motor that displaces or repositions or tilts the light source or a reflector associated therewith so that the light source may generate a beam along a desired path.

Sₛ symbolizes a command signal that energizes a status indicator (e.g. a blue light ring bar) which illuminates when the light fixture lies in communication with the controller.

S_{z} symbolizes a command signal that specifies beam size.

Sₕ symbolizes a command signal that specifies beam shape.

To recap, several embodiments of the disclosed illumination system have (1) one or more electromechanically coupled light fixtures mounted in a ceiling or wall; and (2) one or more controllers, (3) a status identifier associated with one or more light fixtures, and (4) software running in circuitry associated with a controller and/or a light fixture to impart the desired characteristics to the light beam generated by the light fixture (e.g., intensity, color, placement, status, size, and/or shape of the associated beam).

Advantages of the illumination system include:
1. Ease of control by the operator without incursion into or compromising a sanitary environment;
2. Shortened time required by the operator to specify or alter lighting characteristics;
3. Visual indication of the operational state of each light fixture;
4. Capability to move light fixtures or as a group.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A controllable illumination system comprising:
one or more light fixtures;
one or more controllers in communication with at least some of the one or more light fixtures;
a status identifier associated with at least some of the one or more light fixtures that indicates whether an associated light fixture is under the influence of one or more of the controllers; and
software in communication with one or more of the controllers that is adapted to influence one or more beam characteristics of beams that emanate from one or more of the one or more light fixtures or a group thereof, the one or more beam characteristics being selected from the group consisting of beam state (On/Off), beam intensity, beam color, beam movement, beam status indicator, beam size and beam shape that emanate from a light fixture or group of light fixtures.

2. The controllable illumination system of claim 1 wherein one or more of the one or more light fixtures has an intensity that is changeable in response to a signal S_{I} from one or more of the one or more controllers.

3. The controllable illumination system of claim 1 wherein one or more of the one or more light fixtures emits a beam that has a color which changes in response to a signal S_{c} from one or more of the one or more controllers.

4. The controllable illumination system of claim 1 wherein one or more of the one or more light fixtures is associated with a motorized feature, so that the associated light fixture is movable and thus a beam that emanates therefrom is positionable in response to a signal Sₘ from one or more of the one or more controllers, thereby enabling a light beam to be aimed toward a task site.

5. The controllable illumination system of claim 1 wherein a status indicator associated with one or more of the one or more of the one or more light fixtures announces by a visual indication a light fixture status response to a signal Sₛ from one or more of the one or more controllers.

6. The controllable illumination system of claim 5, wherein the status indicator is defined by a parameter selected from the group consisting of beam intensifying, beam dimming, selecting beam color, beam aiming, beam sizing, and beam shaping.

7. The controllable illumination system of claim 1 wherein one or more of the one or more light fixtures emits a beam that has a size that changes in response to a signal S_{z} from one or more of the one or more controllers.

8. The controllable illumination system of claim 1 wherein one or more of the one or more light fixtures emits a beam that has a shape which changes in response to a signal Sₕ from one or more of the one or more controllers.

9. The controllable illumination system of claim 1 wherein one or more of the one or more controllers is wall-mounted or ceiling-mounted.

10. The controllable illumination system of claim 1 wherein one or more of the one or more controllers is hand-held.

11. The controllable illumination system of claim 1 wherein there is a wired communication link between one or more of the one or more controllers and a light fixture.

12. The controllable illumination system of claim 1 wherein there is a wireless communication between one or more of the one or more controllers and a light fixture.

13. The controllable illumination system of claim 1, wherein a single controllable illumination system includes one or more groups of light fixtures so that one or more of the one or more controllers may influence beam characteristics of each light fixture in a group so that a single command may cause each light fixture in the group to emit a beam that has characteristics identical to other light fixtures in that group.

14. The controllable illumination system of claim 1, wherein the illumination system includes one or more motorized light fixtures recessed in a ceiling or wall, one or more of one or more motorized light fixtures having a tilting system that allows the associated light fixture to be selectively directed towards a task site.

15. The controllable illumination system of claim 1, further including a camera for capturing real time images of a task site.

16. The controllable illumination system of claim 1, wherein one or more of the one or more controllers includes a touch screen.

17. The controllable illumination system of claim 1, wherein one or more of the one or more controllers includes a memory function that allows beam characteristics to be stored for later retrieval.

18. A method for controlling an illumination system comprising the steps of:
installing one or more light fixtures so that they are recessed in ceiling or a wall;
communicating one or more controllers with at least some of the one or more light fixtures;
associating a status identifier with one or more of the one or more light fixtures that indicates whether an associated light fixture is under the influence of one or more of the one or more controllers; and
providing software in communication with one or more of the one or more controllers and one or more of the one or more light fixtures, the software being adapted to influence one or more light fixture characteristics, the characteristics being selected from the group consisting of beam state (on/off), beam intensity, beam color, beam position, beam status, beam size and beam shape.
